(19) United States
(12) Patent Application Publication
(10) Pub. No.: US 2026/0336150 A1
(43) Pub. Date: Oct. 29, 2026

(54) CUTTING APPARATUS, FLAT SHEET PROCESSING SYSTEM, AND CONTROL METHOD OF ROTARY CUTTER

(71) Applicant: Horizon Inc., Takashima-shi (JP)

(72) Inventors: Yoshikazu NAKAMURA, Takashima-shi (JP); Ryosuke YAMADA, Takashima-shi (JP)

(73) Assignee: Horizon Inc., Takashima-shi (JP)

(21) Appl. No.: 19/544,710

(22) Filed: Feb. 19, 2026

(30) Foreign Application Priority Data
Feb. 28, 2025 (JP) 2025-032002

(51) Int. Cl. B26D 7/26; B26D 1/147

(52) U.S. Cl. CPC B26D 7/2635; B26D 1/1475

(57) ABSTRACT

A cutting apparatus cuts flat paper S transported by a transport unit 60. The cutting apparatus 1 includes a rotary cutter 10 configured to cut the flat paper S in a direction intersecting a transport direction A, a sheet detection sensor 20 arranged upstream of the rotary cutter 10 on a transport path of the flat paper S and configured to detect a sheet end of the flat paper S, and a cutter controller 30 configured to control the rotary cutter 10. After detection of the sheet end of the flat paper S by the sheet detection sensor 20, the cutter controller 30 controls the speed of the rotary cutter 10 based on a transport speed of the transport unit 60, a position of a cutting blade 12 provided to the rotary cutter 10, and a cutting position on the flat paper S.

### CROSS-REFERENCE TO RELATED APPLICATIONS

This application is based on Japanese Patent Application No. 2025-032002 filed on Feb. 28, 2025, the contents of which are incorporated herein by reference in its entirety.

### BACKGROUND

### 1. Technical Field

The present disclosure relates to a cutting apparatus, a flat sheet processing system, and a control method of a rotary cutter.

### 2. Description of Related Art

For example, a sheet cutting apparatus disclosed in Japanese Patent Application Laid-Open No. 2014-201439 is conventionally known as a cutting apparatus configured to cut sheets (for example, flat paper) during transport.

Patent Literature 1 discloses a cutting unit including a first cutting unit configured to cut a sheet along a transport direction of the sheet fed from a sheet feed unit into a plurality of strip-like sheets, a first direction change unit arranged in the post stage of the first cutting unit and configured to deliver the strip-like sheets in a second direction perpendicular to a first transport direction, and a second cutting unit arranged in the post-stage of the first direction change unit and configured to cut the strip-like sheets along the transport direction (second direction).

The second cutting unit is configured to include a plurality of rotary shafts extending in a direction perpendicular to the transport direction of the strip-like sheets and a plurality of circular blades (round cutters) attached movably relative to each rotary shaft in the shaft direction thereof. Further, in cutting, based on initial information such as sizes of a sheet and a sub-sheet received from a printing apparatus, which is a pre-processing machine, each circular blade is set at a predetermined position, and while passing through the second cutting unit, a strip-like sheet is cut into a plurality of sub-sheets by rotating the blades.

Japanese Patent Application Laid-Open No. 2014-201439 is an example of the related art.

### BRIEF SUMMARY

In the above sheet cutting apparatus disclosed in Japanese Patent Application Laid-Open No. 2014-201439, both the first cutting unit and the second cutting unit perform cutting in the direction along the transport direction. Thus, to cut a sheet along both the longitudinal direction and the width direction, it is required to provide some apparatus that rotates the direction of the sheet by 90 degrees between the first cutting unit and the second cutting unit. This makes it difficult to reduce the size of the apparatus.

Further, a rotary cutter may be used for cutting a roll sheet. Since a roll sheet is a continuous sheet, the transport of the sheet to the rotary cutter is stable. In contrast, since flat sheets are fed intermittently to the rotary cutter, which is likely to be affected by warping, friction, or static electricity of the sheets, and it is difficult to adjust a cutting timing. Thus, the control for roll sheets is not applicable to cutting of flat sheets as it stands.

The present disclosure has been made in view of such circumstances and intends to provide a cutting apparatus, a flat sheet processing system, and a control method of rotary cutter that can stably cut flat sheets in a direction intersecting the transport direction.

One aspect of the present disclosure may provide a cutting apparatus configured to cut a flat sheet transported by a transport device, the cutting apparatus includes: a rotary cutter configured to cut the flat sheet in a direction intersecting a transport direction; a sheet detection device arranged upstream of the rotary cutter on a transport path of the flat sheet and configured to detect a sheet end of the flat sheet; and a controller configured to control the rotary cutter. After detection of the sheet end of the flat sheet by the sheet detection device, the controller may control a speed of the rotary cutter based on a transport speed of the transport device, a position of a cutting blade provided to the rotary cutter, and a cutting position on the flat sheet.

One aspect of the present disclosure may provide a flat sheet processing system including the cutting apparatus described above.

One aspect of the present disclosure may provide a control method of a rotary cutter configured to cut a flat sheet in a direction intersecting a transport direction, the flat sheet being transported by a transport device, and the control method includes: after detecting the flat sheet passing through a reference position virtually set upstream of the rotary cutter on a transport path of the flat sheet, controlling a speed of the rotary cutter based on a transport speed of the transport device, a position of a cutting blade provided to the rotary cutter, and a cutting position on the flat sheet.

One aspect of the present disclosure may provide a program that causes a computer to perform the control method of the rotary cutter described above.

It is possible to cut sheets continuously, in a direction intersecting the transport direction of the sheets.

### BRIEF DESCRIPTION OF THE SEVERAL VIEWS OF THE DRAWINGS

FIG. 1 is a diagram illustrating a general configuration of a cutting apparatus according to a first embodiment of the present disclosure.

FIG. 2 is a diagram schematically illustrating cutting performed by the cutting apparatus according to the first embodiment of the present disclosure.

FIG. 3 is a diagram illustrating rotational position control of a rotary cutter according to the first embodiment of the present disclosure.

FIG. 4 is a diagram illustrating an example of a hardware configuration of a cutter controller according to the first embodiment of the present disclosure.

FIG. 5 is a flowchart illustrating an example of a processing procedure of the control method of the rotary cutter according to the first embodiment of the present disclosure.

FIG. 6 is a flowchart illustrating an example of a processing procedure of a synchronization process according to the first embodiment of the present disclosure.

FIG. 7 is a flowchart illustrating an example of a processing procedure of a continuous cutting process according to the first embodiment of the present disclosure.

FIG. 8 is a diagram illustrating a first threshold, a second threshold, and a stop threshold according to the first embodiment of the present disclosure.

FIG. 9 is a diagram illustrating an example of a pulse table according to the first embodiment of the present disclosure.

FIG. 10 is a diagram illustrating a speed control of the rotary cutter according to the first embodiment of the present disclosure.

FIG. 11 is a diagram illustrating an example of a system configuration diagram of a bookbinding system according to one embodiment of the present disclosure.

### DETAILED DESCRIPTION

### First Embodiment

A cutting apparatus and a control method of a rotary cutter according to a first embodiment of the present disclosure will be described below with reference to the drawings. Although description will be provided below with flat paper being as an example of a flat sheet, the flat sheet is not limited thereto. For example, the flat sheet may be a material other than paper, such as a film, plastic, or the like. As used herein, the term “flat sheet” refers to a discrete sheet having a predetermined size and does not include a sheet provided in a continuous roll form, including a web.

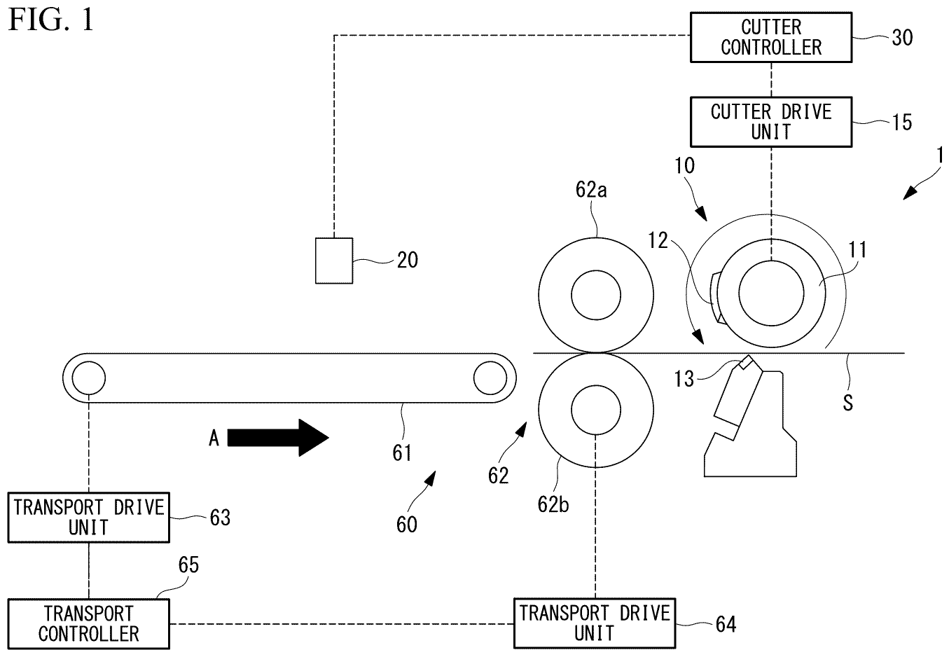

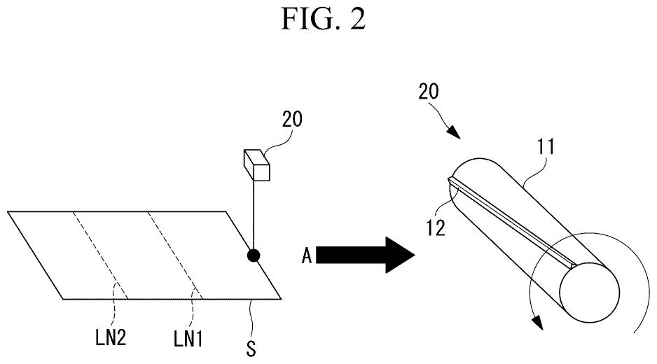

FIG. 1 illustrates a general configuration of a cutting apparatus 1 according to the first embodiment of the present disclosure. FIG. 2 is a diagram schematically illustrating cutting performed by the cutting apparatus 1 according to the present embodiment.

The cutting apparatus 1 includes a rotary cutter 10, a sheet detection sensor (sheet detection device) 20 configured to detect flat paper (flat sheet) S, and a cutter controller (controller) 30.

For example, the flat paper S is transported to the cutting apparatus 1 by the transport unit (transport device) 60. The transport unit 60 has, for example, a suspension type belt conveyer 61 and a transport roller pair 62. The transport roller pair 62 includes an upper roller 62a and a lower roller 62b.

For example, the belt conveyer 61 is driven by a transport drive unit 63. For example, the transport roller pair 62 is driven by a transport drive unit 64. For example, the transport drive units 63, 64 have a servo motor. The transport drive units 63, 64 are controlled by a transport controller 65. The belt conveyer 61 and the transport roller pair 62 are synchronously controlled by the transport controller 65, and thereby the flat paper S is transported stably at the same speed.

The transport roller pair 62 is provided with a speed detection sensor for determining the transport speed. For example, the speed detection sensor outputs pulses in accordance with the transport speed. The speed detection sensor may be, for example, a rotary encoder (not illustrated). The output signal from the rotary encoder is transmitted to the cutter controller 30 described later.

For example, the rotary cutter 10 cuts the flat paper S, which is transported by the transport unit 60, in a direction intersecting a transport direction A. Specifically, the cutting apparatus 1 cuts the flat paper S in the direction perpendicular to the transport direction A. FIG. 2 illustrates an example of cutting the flat paper S on two lines of cutting lines (cutting positions) LN1, LN2.

The rotary cutter 10 has a rotatably supported cylindrical base 11 and a cutting blade 12 arranged on the outer circumferential face of the base 11. As illustrated in FIG. 2, the cutting blade 12 is provided so as to extend in the rotational axis direction of the base 11. In other words, the cutting blade 12 is provided so as to extend from one end to the other end of the base 11. For example, the cutting blade 12 may be provided diagonally with respect to the rotational axis direction of the base 11 as illustrated in FIG. 2 or may be provided parallel to the rotational axis direction.

The cutting blade 12 is provided in a direction (diagonally) intersecting the rotational axis direction of the base 11, and thereby the flat paper S can be gradually cut as if it were cut by scissors. In such a case, to cut the flat paper S in the direction perpendicular to the transport direction A, the rotary cutter 10 is installed diagonally so as to form a predetermined angle relative to the direction perpendicular to the transport direction A.

A fixed blade 13 is arranged at a position opposite to the rotary cutter 10 via the transport path. The cutting blade 12 provided to the rotary cutter 10 is engaged with the fixed blade 13, and thereby the transported flat paper S is cut.

The sheet detection sensor 20 is installed upstream from the rotary cutter 10 in the transport direction A of the flat paper S. For example, in response to detecting a front end of the flat paper S in the transport direction A, the sheet detection sensor 20 outputs a sensor detection signal to the cutter controller 30.

The rotary cutter 10 is driven by a cutter drive unit 15. For example, the cutter drive unit 15 has a servo motor.

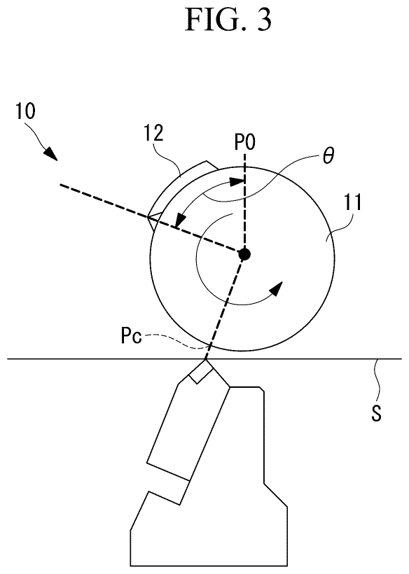

The cutter controller 30 controls the rotational speed of the rotary cutter 10. For example, the cutter controller 30 controls the speed of the rotary cutter 10 based on the transport speed of the transport unit 60, the position (rotational position θ) of the cutting blade 12 provided to the rotary cutter 10, and the cutting line (for example, LN1, LN2 of FIG. 3) on the flat paper S.

Specifically, the cutter controller 30 provides a speed control instruction (instruction pulse) to the cutter drive unit 15 to control the rotational speed of the rotary cutter 10.

For example, the cutter controller 30 acquires information about the transport speed of the transport unit 60. For example, the cutter controller 30 is configured to be able to receive a pulse signal from a rotary encoder provided to the transport roller pair 62 of the transport unit 60 (hereafter, referred to as “transport encoder”).

Further, for example, as illustrated in FIG. 3, the rotary cutter 10 is provided with a rotational position detection unit (not illustrated) in order to detect the rotational position θ of the cutting blade 12 relative to the reference position P0 virtually set to the base 11. An example of the rotational position detection unit may be a rotary encoder.

The cutter controller 30 calculates a rotational position (0° to 360°) of the cutting blade 12 relative to the reference position P0 based on the output pulse from the rotational position detection unit. Although FIG. 3 illustrates the case where the uppermost point is set as the reference position P0) (0° as an example, the reference position P0 can be set at any position. Further, in the following description, the position at which the cutting blade 12 engages with the fixed blade 13 to cut the flat paper S is denoted as a cut position Pc.

Further, when the cutting blade 12 is provided diagonally with respect to the rotational axis of the base 11 as illustrated in FIG. 2, the reference of the rotational position of the cutting blade 12 can be set at any position. In the present embodiment, as illustrated in FIG. 3, the most preceding position of the cutting blade 12 in the rotational direction is set as the reference position.

For example, when the cutting apparatus 1 is applied to a bookbinding system, the cutting lines LN1, LN2 (see FIG. 2) on the flat paper S can be acquired from job data supplied from a higher-level system that manages each apparatus of the bookbinding system or a pre-processing apparatus (for example, a printing apparatus) that performs pre-processing (for example, printing) on the flat paper S, or the like. Such job data includes information on sizes of the flat paper S, impositions on the flat paper S, margins, or the like. The cutter controller 30 identifies the cutting lines LN1, LN2 on the flat paper S from the job data.

Further, based on the transport speed of the transport unit 60 described above, the rotational position θ of the cutting blade 12 of the rotary cutter 10, and the cutting lines LN1, LN2 on the flat paper S, the cutter controller 30 controls the rotational speed of the rotary cutter 10 so that the cutting blade 12 reaches the cut position Pc at a timing the cutting lines LN1, LN2 reach the cut position Pc.

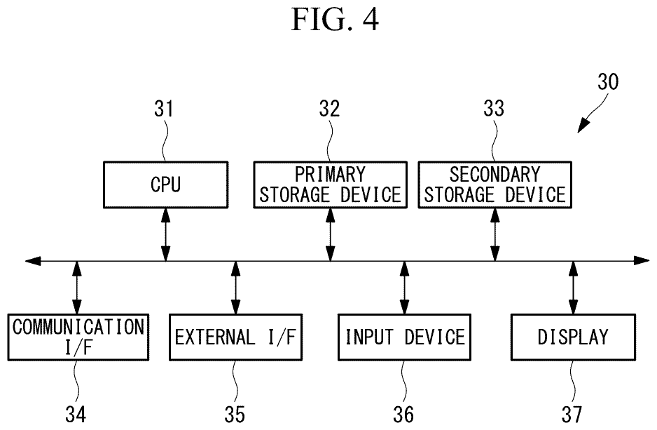

FIG. 4 is a diagram illustrating an example of a hardware configuration of the cutter controller 30.

The cutter controller (controller) 30 is a computer and includes, for example, a central processing unit (CPU: processor) 31, a primary storage device (main memory) 32, a secondary storage device (memory) 33, and the like.

Furthermore, the cutter controller 30 may include a communication interface 34 for transmitting or receiving information to and from another apparatus, an external interface 35 for connecting an external device thereto, an input device 36 for the user to perform input operation, a display 37 for displaying data, and the like.

One or a plurality of CPUs 31 are provided and may cooperate with each other to implement processes.

For example, the primary storage device 32 is formed of a writable memory such as a random access memory (RAM) or the like, reads an execution program of the CPU 31, and is used as a working area in which writing of processing data or the like are performed in accordance with the execution program. A plurality of primary storage devices 32 may be provided.

The secondary storage device 33 is a non-transitory computer readable storage medium. The secondary storage device 33 is, for example, a semiconductor memory or the like and may be a flash memory, a solid state drive (SSD), or the like as an example. Further, another example of the secondary storage device 33 may be a magnetic disk, a magneto-optical disk, a CD-ROM, a DVD-ROM, or the like. A plurality of secondary storage devices 33 may be provided. Programs or data for implementing processes (functions) described later may be stored in respective secondary storage devices 33 in a divided manner.

A series of processes for implementing various functions are stored in the secondary storage device 33 in a form of a program as an example, and the various functions are implemented when the CPU 31 loads this program into the primary storage device 32 and performs modification and calculation processing on information. Note that, for the program, a form of being installed in advance in the secondary storage device 33, a form of being provided in a state of being stored in a computer readable storage medium, a form of being delivered via a wired or wireless communication unit, or the like may be applied. The computer readable storage medium may be a magnetic disk, a magneto-optical disk, a CD-ROM, a DVD-ROM, a semiconductor memory, or the like.

An example of the cutter controller 30 may be a microcontroller (MCU), programmable logic controller (PLC), a field programmable gate array (FPGA), or the like.

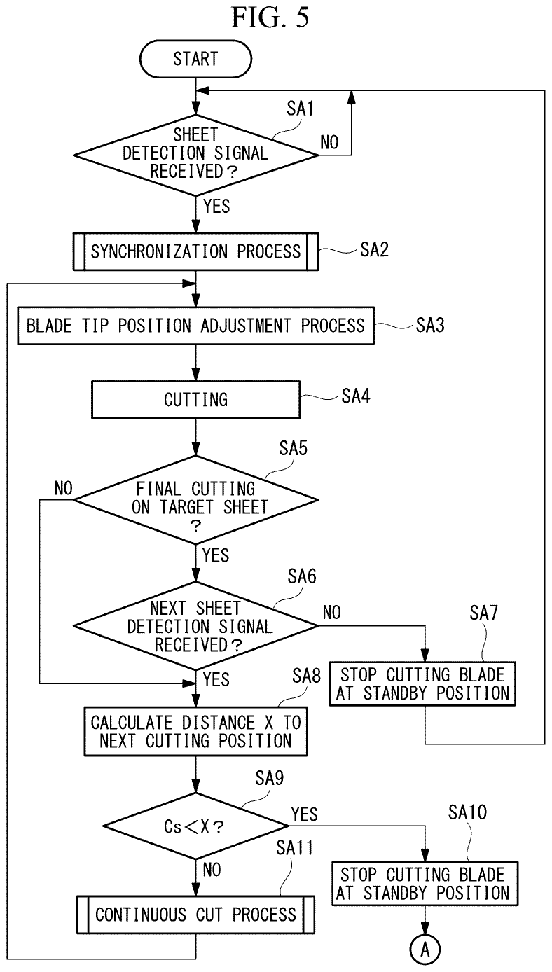

Next, a control method of the rotary cutter 10 performed by the cutter controller 30 will be described with reference to FIG. 5. FIG. 5 is a flowchart illustrating an example of the processing procedure of the control method of the rotary cutter 10 according to the present embodiment.

First, upon receiving a sheet detection signal from the sheet detection sensor in response to detection of the flat paper S (hereafter, referred to as “target sheet”) by the sheet detection sensor 20 (SA1: YES), the cutter controller 30 performs a synchronization process to synchronize the speed of the rotary cutter 10 with the speed of the transport unit 60 (SA2). Hereafter, the speed of the rotary cutter 10 synchronized with the transport speed is referred to as a synchronization speed.

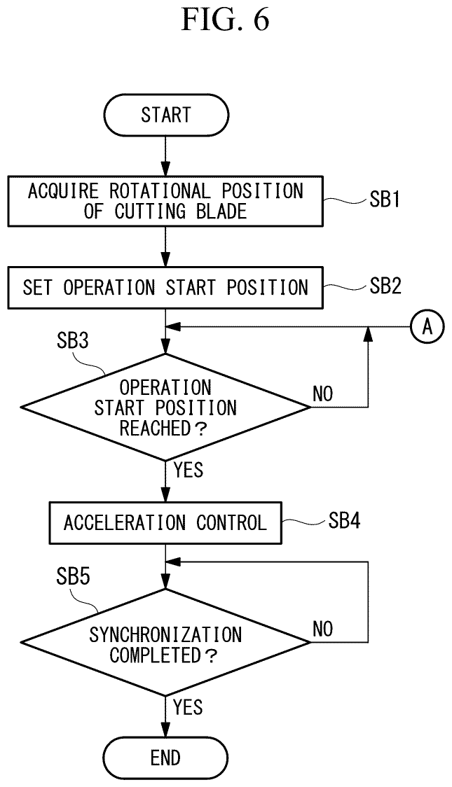

FIG. 6 is a flowchart illustrating an example of a processing procedure of the synchronization process performed in step SA2. As illustrated in FIG. 6, first, the cutter controller 30 acquires the rotational position θ of the cutting blade 12 (SB1).

Subsequently, the cutter controller 30 sets an operation start position (SB2). Specifically, the cutter controller 30 uses each current value with respect to a predetermined calculation formula whose parameters are a cutting line on a target sheet (the distance from the sheet leading end) and the rotational position θ of the cutting blade 12 and thereby sets the operation start position on the transport path. Further, this calculation formula includes values such as an acceleration to be applied to the rotary cutter 10 after start of operation. Accordingly, the rotational position θ of the cutting blade 12 can be rotated to a preferable position relative to the cutting line at completion of synchronization described later.

Next, it is determined whether or not the cutting line of the target sheet has reached the operation start position on the transport path (SB3). As a result, if the cutting line of the target sheet has not reached the operation start position, the process stands by until the cutting line of the target sheet reaches the operation start position (SB3: NO). Note that the position that the target sheet reached is found by calculation based on a time elapsed from detection performed by the sheet detection sensor 20 and a transport speed.

Then, in response to the cutting line on the target sheet reaching the operation start position (SB3: YES), the cutter controller 30 starts operation of the rotary cutter 10 to perform acceleration control (SB4). Note that details about the acceleration control will be described later.

Subsequently, the cutter controller 30 determines whether or not the rotational speed of the rotary cutter 10 is synchronized with the transport speed (SB5). As a result, if no synchronization is determined, in other words, if the rotational speed of the rotary cutter 10 is not the same as the transport speed (SB5: NO), the acceleration control is performed until these speeds become the same. Then, if the rotational speed of the rotary cutter 10 is synchronized with the transport speed (SB5: YES), the present synchronization process ends.

Accordingly, the process proceeds to a blade tip position adjustment process illustrated in FIG. 5 (SA3).

In the blade tip position adjustment process (SA3 of FIG. 5), it is determined whether or not the rotational angle of the cutting blade 12 and the cutting line on the target sheet are in synchronization. Specifically, the cutter controller 30 determines whether or not the time the cutting line on the target sheet reaches the cut position Pc and the time the cutting blade 12 reaches the cut position Pc are the same. Accordingly, when there is a difference between these times, the rotational speed of the rotary cutter 10 is increased or reduced for adjustment so that both the timings become the same.

Accordingly, the rotational angle of the cutting blade 12 is suitably adjusted, and the target sheet is cut on the cutting line (SA4).

Subsequently, the cutter controller 30 determines whether or not the cutting in step SA4 is the final cutting on the target sheet (SA5). As a result, if the cutting is not the final cutting (SA5: NO), the process proceeds to step SA8.

In contrast, if the cutting is the final cutting (SA5: YES), it is determined whether or not a next sheet detection signal has been received (SA6). In other words, it is determined whether or not new flat paper S is detected by the sheet detection sensor. As a result, if the next sheet detection signal has not been received (SA6: NO), the process proceeds to step SA7 to stop the cutting blade 12 at a standby position (=reference position P0), returns to step SA1, and enters the standby state until the next sheet detection signal is received.

In contrast, in step SA6, if the next sheet detection signal has been received (SA6: YES), the cutter controller 30 calculates a distance X to the next cutting position (cutting line) (SA8). Subsequently, it is determined whether or not the distance X is greater than a stop threshold Cs set in advance (SA9).

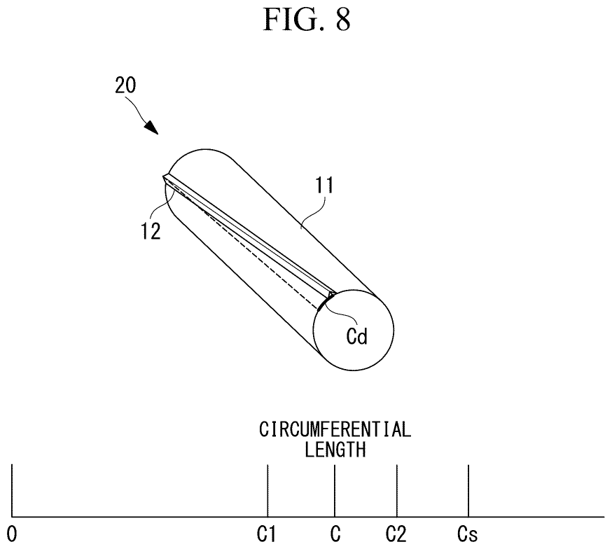

Herein, the stop threshold Cs is set to a value that is greater than the circumferential length C of the rotary cutter 10, as illustrated in FIG. 8. Specifically, the stop threshold Cs is set to a transport distance of the flat paper S, which corresponds to a period in which the rotary cutter 10 is rotated by one turn at the lowest speed (the lower limit speed), or set to a value smaller by a predetermined value than such a transport distance. Herein, the lowest speed is a speed lower than the synchronization speed.

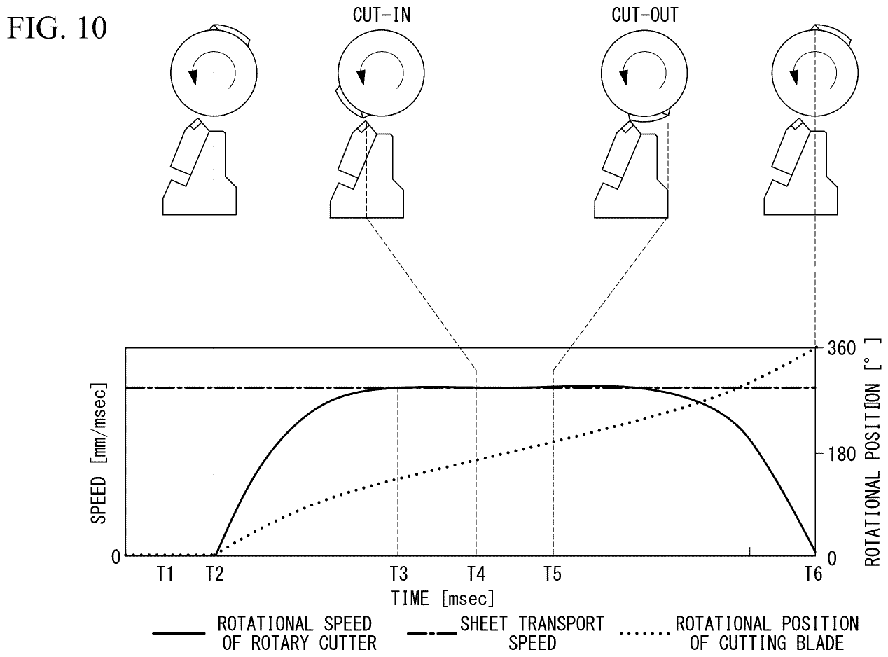

As illustrated in FIG. 2 and FIG. 8, when the cutting blade 12 is provided diagonally with respect to the rotational axis direction of the base 11, the stop threshold Cs is set to, for example, a transport distance of the flat paper S corresponding to a period of rotation at the lowest speed (the lower limit speed) for a distance obtained by subtracting a circumferential distance Cd from one end to the other end of the cutting blade 12 from the circumferential length C of the rotary cutter 10 (=C−Cd), in other words, a period from a cut-out (time T5) illustrated in FIG. 10 to the next cut-in (time T3). Further, the stop threshold Cs may be set to a value smaller by a predetermined value than such a transport distance with a predetermined margin.

If the distance X exceeds the stop threshold Cs (SA9: YES), the cutting line will not reach the cut position Pc until the cutting blade 12 reaches the cut position Pc even when the rotary cutter 10 is rotated at the lowest speed. Therefore, in such a case, the process proceeds to step SA10 to stop the cutting blade 12 at the standby position (=reference position P0) and then proceeds to step SB3 of FIG. 6. Accordingly, the standby state continues until the next cutting line reaches the operation start position (SB3 of FIG. 6).

In contrast, if the distance X is less than or equal to the stop threshold Cs (SA9: NO), the process proceeds to step SA11 to perform a continuous cut process and returns to step SA3.

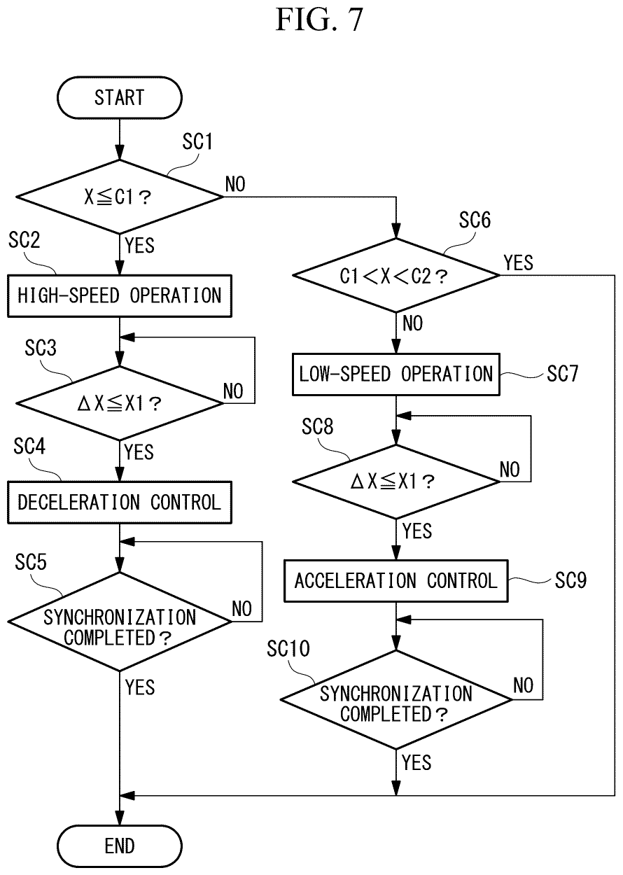

Next, the continuous cut process will be described with reference to FIG. 7. FIG. 7 is a flowchart illustrating an example of the processing procedure of the continuous cut process.

First, the cutter controller 30 determines whether or not the distance X is less than or equal to a first threshold C1 set in advance (SC1). Herein, the first threshold C1 is set to a value that is shorter by a predetermined distance than the circumferential length C of the rotary cutter 10, as illustrated in FIG. 8.

If the distance X is less than or equal to the first threshold C1 (SC1: YES), the cutter controller 30 reduces the speed after rotating the rotary cutter 10 at a rotational speed that is higher than the transport speed of the flat paper S to synchronize the rotational speed of the rotary cutter 10 with the transport speed.

Specifically, first, the cutter controller 30 increases the rotational speed of the rotary cutter 10 to perform high-speed operation for rotation at a higher speed than the transport speed of the flat paper S (SC2).

Subsequently, the cutter controller 30 calculates the distance Xc from the current rotational position θ to the cut position Pc of the cutting blade 12 and the distance X to the cutting line (the distance from the cut position Pc to the cutting line) and calculates the difference therebetween, ΔX (=X−Xc). It is then determined whether or not the difference ΔX is less than or equal to a predetermined value X1 (SC3). As a result, if the difference ΔX is not less than or equal to the predetermined value X1 (SC3: NO), the high-speed operation is continued. Then, if the difference ΔX is less than or equal to the predetermined value X1 (SC3: YES), deceleration control is performed to reduce the speed of the rotary cutter 10 (SC4) to be synchronized with the transport speed.

Then, if the rotational speed of the rotary cutter 10 and the transport speed are in synchronization (SC5: YES), the continuous cut process ends.

Next, in step SC1, if the distance X is not less than or equal to the first threshold C1 (SC1: NO), it is determined whether or not the distance X is greater than the first threshold C1 and less than a second threshold C2 (SC6). Herein, the second threshold C2 is set to a value that is longer by a predetermined distance than the circumferential length C of the rotary cutter 10, as illustrated in FIG. 8. Further, the second threshold C2 is set to a value that is smaller than the stop threshold Cs.

If the distance X is greater than the first threshold C1 and less than a second threshold C2 (SC6: YES), the cutter controller 30 terminates the present process. More specifically, the case where the distance X is greater than the first threshold C1 and less than a second threshold C2 means that the distance X is substantially the same length as the circumferential length C of the rotary cutter 10. In such a case, it is not required to perform the high-speed operation (SC3) described above or the low-speed operation (SC7) described later. Therefore, the present process ends while the synchronization control to follow the transport speed is maintained. In such a case, the position adjustment of the cutting blade 12 will be performed in the blade tip position adjustment process in step SA3 of FIG. 5 described above.

In contrast, in step SC6, if the distance X is greater than the first threshold C1 and not less than the second threshold C2 (SC6: NO), in other words, if the distance X is greater than or equal to the second threshold C2 and less than or equal to the stop threshold Cs, the rotational speed of the rotary cutter 10 is increased after rotation at a lower speed than the transport speed of flat paper to synchronize the rotational rate of the rotary cutter 10 with the transport speed.

Specifically, the cutter controller 30 performs low-speed operation to reduce the rotational speed of the rotary cutter 10 (SC7). Subsequently, the cutter controller 30 calculates the distance Xc from the current rotational position θ to the cut position Pc of the cutting blade 12 and the distance X to the cutting line (the distance from the cut position Pc to the cutting line) and calculates the difference therebetween, ΔX (=X-Xc). It is then determined whether or not the difference ΔX is less than or equal to a predetermined value X1 (SC8). As a result, if the difference ΔX is not less than or equal to the predetermined value X1 (SC8: NO), the low-speed control is continued. Then, if the difference ΔX is less than or equal to the predetermined value X1 (SC8: YES), acceleration control is performed to increase the speed of the rotary cutter 10 (SC9) to be synchronized with the transport speed.

Then, if the rotational speed of the rotary cutter 10 and the transport speed are in synchronization (SC10: YES), the continuous cut process ends.

In such a way, after completion of the continuous cut process, the process returns to step SA3 of FIG. 5, the blade tip position adjustment process is performed, cutting is performed on the next cutting line (SA4), and the subsequent process is repeatedly performed.

Next, an example of the control of the cutter drive unit 15 performed by the cutter controller 30 described above will be described. The cutter controller 30 outputs instruction pulses to the cutter drive unit 15 to control the rotational speed of the rotary cutter 10.

For example, the cutter controller 30 has information in which the number of input pulses of the transport encoder is associated with the number of instruction pulses in synchronization control, and the cutter controller 30 uses this information to perform speed control of the rotary cutter 10. When performing the high-speed operation, the cutter controller 30 increases the ratio of the number of instruction pulses relative to the number of input pulses of the transport encoder compared to the ratio applied during the synchronization control, and when performing the low-speed operation, the cutter controller 30 reduces the ratio of the number of instruction pulses relative to the number of input pulses of the transport encoder compared to the ratio applied during the synchronization control.

Further, in the blade tip position adjustment process (SA3 of FIG. 5), the speed of the rotary cutter 10 is increased or reduced by a stepwise change of the ratio of the number of instruction pulses relative to the number of input pulses of the transport encoder.

More specifically, the cutter controller 30 has a pulse table in which the number of transport pulses in accordance with the transport speed of flat paper, in other words, the number of pulses of the transport encoder is associated with instruction pulses related to the rotational speed of the rotary cutter 10, in other words, timings to output instruction pulses related to the rotational speed of the rotary cutter. Further, the cutter controller 30 uses the pulse table and the number of transport pulses input from the transport unit 60 to perform speed control of the rotary cutter 10.

In the pulse table, an output timing of instruction pulses is set for each of a plurality of speed levels.

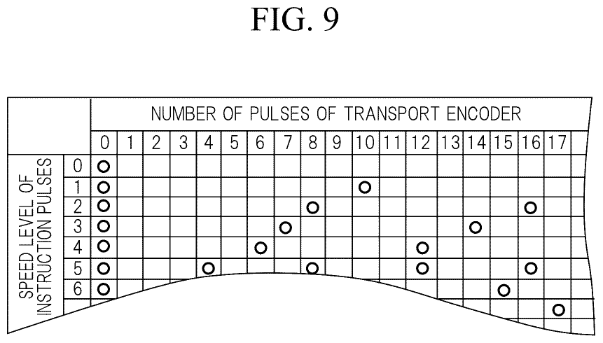

FIG. 9 illustrates an example of the pulse table. As illustrated in FIG. 9, output timings of instruction pulses are listed in association with the number of pulses of the transport encoder for each speed level of instruction pulses. For example, timings indicated with O (circles) each represent a timing to output an instruction pulse. For example, it is indicated that, in a case of the speed level of “5”, instruction pulses are output when the number of pulses of the transport encoder is 0, 4, 8, 12, and 16. In such a way, in the pulse table, timings to output the instruction pulses are set at equal intervals for respective speed levels.

In each of the high-speed operation (SC2 of FIG. 7) and the low-speed operation (SC7 of FIG. 7), speed levels to be applied are registered in advance. The cutter controller 30 references a pulse table for corresponding speed levels in the high-speed operation and the low-speed operation, and an instruction pulse is output with the number of pulses of the transport encoder defined in the pulse table.

Further, in the blade tip position adjustment process (SA3 of FIG. 5), the speed level to be employed is changed stepwise to increase or reduce the speed of the rotary cutter 10. More specifically, an error in the positional relationship between a rotational position of the cutting blade and a cutting line is converted into the number of instruction pulses, and the number of instruction pulses is increased or reduced so as to cancel the converted number of instruction pulses. For example, when the rotational position of the cutting blade 12 is delayed with respect to the cutting line, the instruction pulse is additionally output at the currently employed speed level in order to advance the rotational position of the cutting blade 12. Contrarily, when the rotational position of the cutting blade 12 is advanced with respect to the cutting line, output of some of the instruction pulses is omitted at the currently employed speed level in order to delay the rotational position of the cutting blade 12.

In such a way, since the instruction pulses can be adjusted on a pulse basis in the blade tip position adjustment process, precise control can be achieved compared to the high-speed operation or the low-speed operation described above. Further, because a difference in speed from a synchronization speed can be suppressed to +25% at the maximum, high responsiveness can be achieved.

Further, in the case of the acceleration control (SB4 of FIG. 6, SC9 of FIG. 7), the number of input pulses is continuously switched so that the speed level is gradually increased at a predetermined speed change cycle, in other words, at every time the number of input pulses of the transport encoder reaches a predetermined pulse count N.

Further, likewise in the case of the deceleration control (SC4 of FIG. 7), the number of input pulses is continuously switched so that the speed level is gradually reduced at a predetermined speed change cycle, in other words, at every time the number of input pulses of the transport encoder reaches the predetermined pulse count N.

Next, the operation of the cutting apparatus 1 according to the present embodiment will be briefly described with reference to FIG. 5 to FIG. 7 and FIG. 10.

First, at time T1 of FIG. 10, the flat paper S (target sheet) is detected by the sheet detection sensor 20, and in response to a sheet detection signal being input to the cutter controller 30 (SA2 of FIG. 5), the cutter controller 30 calculates and sets an operation start position (SB2 of FIG. 6).

Then, at time T2 of FIG. 10, in response to the target sheet reaching the operation start position, the cutter controller 30 starts acceleration control to increase the speed of the rotary cutter 10 (SB4). Accordingly, for example, instruction pulses are output to the cutter drive unit 15 based on the pulse table (see FIG. 9) for the acceleration control, and the rotational speed of the rotary cutter 10 is gradually increased (time T2 to T3 of FIG. 10). Then, at time T3, upon completion of synchronization between the rotational speed of the rotary cutter 10 and the transport speed, the blade tip position adjustment process is performed where necessary (SA3 of FIG. 5). Specifically, the cutter controller 30 determines whether or not the rotational angle of the cutting blade 12 and the cutting line of the target sheet are synchronized with each other, and if an error is present, the rotational speed of the rotary cutter 10 is increased or reduced for adjustment so that both the timings thereof become the same.

Subsequently, the target sheet is cut from time T4 (cut-in) to time T5 (cut-out) of FIG. 10. During cutting of the target sheet, for example, synchronization control is performed to synchronize the transport speed and the speed of the rotary cutter 10 with each other.

Next, after cutting at time T5, determination as to whether or not the cutting is the final cutting on the target sheet (SA5 of FIG. 5), whether or not the next sheet detection signal has been received (SA6), or whether or not the distance X exceeds the stop threshold (SA9) is performed, and based on results of such determination, it is determined whether to stop operation or perform continuous cutting. When operation is stopped, the rotational speed is gradually reduced (time T5 to T6 of FIG. 10), and the rotary cutter 10 is stopped at time T6. At this time, the position of the cutting blade 12 is adjusted to the standby position (=P0). On the other hand, when the continuous cut process is performed, the speed control of the rotary cutter 10 in accordance with the distance X is performed (see mainly FIG. 7).

As described above, according to the present embodiment, the cutting apparatus 1 includes: the rotary cutter 10 configured to cut the flat paper S in a direction intersecting the transport direction A; the sheet detection sensor 20 arranged upstream of the rotary cutter 10 in a transport path of the flat paper S and configured to detect a sheet end of the flat paper S; and the cutter controller 30 configured to control the rotary cutter 10. Further, the cutter controller 30 controls the speed of the rotary cutter 10 based on the transport speed of the transport unit 60, the position θ of the cutting blade 12 provided to the rotary cutter 10, and the cutting line on the flat paper S after detection of the sheet end of the flat paper S by the sheet detection sensor 20.

Accordingly, the flat paper S can be stably cut in a direction intersecting the transport direction A of the flat paper S by using the rotary cutter 10. As a result, when the flat paper S is required to cut both in the longitudinal direction and the width direction and the subsequent cutting process is performed, it is no longer necessary to rotate the flat paper by 90 degrees as with the conventional art. Thus, a reduction in size of the apparatus can be achieved.

In the present embodiment, the cutter controller 30 performs a synchronization process to match the rotational speed of the rotary cutter 10 with the transport speed of the flat paper S in response to detection of the sheet end of the flat paper S by the sheet detection sensor 20, and performs a blade tip position adjustment process to increase or reduce the rotational speed of the rotary cutter 10 so that the position of the cutting blade 12 is aligned with the cutting line on the flat paper S in response to completion of the synchronization process.

As described above, the blade tip position adjustment process is performed after the synchronization process is performed, thereby the position of the cutting blade 12 can be substantially aligned with the cutting line, and a cutting error can be reduced.

In the present embodiment, after cutting of the flat paper S and when the cutting is not final cutting the flat paper (target sheet) or when the next flat paper is detected by the sheet detection sensor 20, the cutter controller 30 performs a continuous cutting process to perform speed control of the rotary cutter 10 based on the distance X to a next cutting position.

Accordingly, even when a plurality of cutting lines are set on the flat paper S, it is possible to continuously perform cutting without stopping the transportation of the flat paper S. Further, it is possible to perform stable continuous cutting by performing speed control in accordance with the distance X.

In the present embodiment, in the continuous cutting process, when the distance X to the next cutting position is less than or equal to the predetermined first threshold C1 set to a value less than the circumferential length C of the rotary cutter 10, the cutter controller 30 synchronizes the rotational speed of the rotary cutter 10 with the transport speed by reducing the rotational speed of the rotary cutter 10 after rotating the rotary cutter at a rotational speed higher than the transport speed (synchronization speed) of the flat paper S.

As described above, when the distance X is less than or equal to the first threshold C1, the rotary cutter is rotated at a higher rotational speed than the synchronization speed, and the rotational speed is then reduced to be the same as the synchronization speed. Accordingly, even when the distance to the next cutting position is relatively short, stable cutting can be achieved.

In the present embodiment, when the distance X to the next cutting position is greater than or equal to the predetermined second threshold C2 set to a value greater than the circumferential length C of the rotary cutter 10 and is less than or equal to the stop threshold Cs, the cutter controller 30 synchronizes the rotational speed of the rotary cutter 10 with the transport speed by increasing the rotational speed of the rotary cutter 10 after rotating the rotary cutter 10 at a rotational speed lower than the transport speed of the flat paper S. Herein, the stop threshold Cs is set greater than the second threshold and less than or equal to a transport distance corresponding to a period required for rotating the rotary cutter 10 for one turn at the lowest speed.

As described above, when the distance X is greater than or equal to the second threshold C2 and less than or equal to the stop threshold Cs, the rotary cutter 10 is rotated at a speed lower than the synchronization speed, and the rotational speed is then increased to be the same as the synchronization speed. Accordingly, even when the distance to the next cutting position is relatively long, stable cutting can be achieved.

In the present embodiment, when the distance X to the next cutting position is greater than the predetermined first threshold C1 set to a value less than the circumferential length C of the rotary cutter 10 and is less than the predetermined second threshold C2 set to a value greater than the circumferential length C of the rotary cutter 10, the cutter controller maintains synchronization control for synchronization with the transport speed.

Accordingly, the rotary cutter 10 can be rotated at a stable speed.

In the present embodiment, after cutting of the flat paper S and when the cutting is the final cutting the flat paper (target sheet) and the next flat paper S is not detected by the sheet detection sensor 20, the cutter controller 30 stops the rotary cutter 10 at a predetermined rotary angle.

Accordingly, useless rotation of the rotary cutter 10 can be suppressed.

In the present embodiment, when the distance X to the next cutting position is greater than the stop threshold Cs after cutting of the flat paper S, the cutter controller 30 stops the rotary cutter 10 at a predetermined rotary angle

Accordingly, useless rotation of the rotary cutter 10 can be suppressed.

In the present embodiment, the cutter controller 30 has a pulse table in which the number of transport pulses in accordance with the transport speed of the flat paper S and a timing to output an instruction pulse related to the rotational speed of the rotary cutter 10 are associated with each other. Further, the cutter controller 30 performs speed control of the rotary cutter 10 by using the pulse table and the number of transport pulses input from the transport unit 60.

Accordingly, the control of the rotary cutter 10 can be simplified, and the speed control can be easily achieved.

In the present embodiment, the pulse table is provided for each speed level of the rotary cutter 10, and the cutter controller 30 changes the speed of the rotary cutter 10 by switching the pulse table to be used.

Accordingly, the speed of the rotary cutter 10 can be easily changed. Further, since the control is defined on a speed level basis, stable speed control can be achieved.

### Second Embodiment

Next, a cutting apparatus and a control method of a rotary cutter according to a second embodiment of the present disclosure will be described with reference to the drawings.

In the first embodiment described above, control to match the rotational speed of the rotary cutter 10 with the transport speed is performed in the synchronization process in step SA2 of FIG. 5. Further, after completion of the synchronization, instruction pulses in accordance with the number of pulses detected by the transport encoder are output from the cutter controller 30 to the cutter drive unit 15, and thereby the synchronized state is maintained.

For example, as illustrated in time T3 to T5 of FIG. 10, the transport speed is typically constant, and the rotational speed of the rotary cutter 10 controlled in accordance therewith will be the same as the transport speed.

However, the flat paper S may be slightly pushed back due to resistance occurring during contact between the cutting blade 12 and the flat paper S, and the transport speed may be slightly reduced. In such a case, the reduction in the transport speed will be detected by the transport encoder, and the synchronization control based on the reduced transport speed will be performed in the cutter controller 30. That is, control to reduce the speed of the rotary cutter 10 to follow the reduced transport speed is performed. This may further increase the resistance against the flat paper S during cutting (see time T4 to T5 of FIG. 10) and cause a vicious cycle of further reduction in the rotational speed of the rotary cutter 10. Since such a change in speed occurs in a significantly short time, the cutter drive unit (servo motor) 15 may be unable to fully follow the change. Further, such a phenomenon may cause the actual cutting precision to be deteriorated than is expected despite the fact that the change in the transport speed of the flat paper S is within the tolerable range defined by the specification.

To solve such a problem, the cutting apparatus and the control method of the rotary cutter according to the present embodiment control the rotary cutter 10 so as to maintain the speed occurring at completion of the synchronization process without performing the follow-control to follow the transport speed of the flat paper S during cutting (for example, time T4 to T5 of FIG. 10).

Specifically, after a synchronization process according to the first embodiment described above is performed and the rotational speed of the rotary cutter 10 is synchronized with the transport speed, the synchronization speed is maintained. More specifically, until cutting ends, in other words, in a period from the cut-in (time T4) to the cut-out (time T5) of FIG. 10, constant instruction pulses are output to the cutter drive unit 15 regardless of the number of input pulses from the transport encoder, and thereby the rotary cutter 10 is rotated at a constant speed.

As described above, according to the present embodiment, in at least a period from the start of cutting at the cutting position of the flat paper S (for example, time T4 of FIG. 10) to the end of the cutting (for example, time T5 of FIG. 10), the rotary cutter 10 is rotated at a synchronization speed applied before the cutting regardless of the transport speed.

Accordingly, it is possible to avoid a reduction in cutting precision due to an instance where the transport speed of the flat paper S is slightly reduced by resistance occurring during contact between the cutting blade 12 and the flat paper S.

### Applicable Example

Next, an example of a flat sheet processing system to which the cutting apparatus 1 and the control method of the rotary cutter 10 according to the first or second embodiment described above are applied will be described.

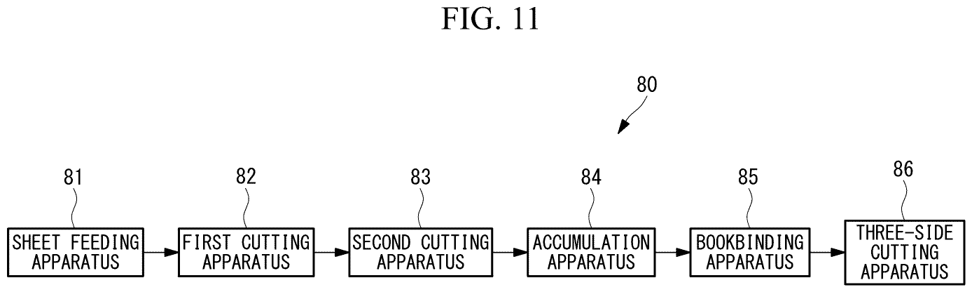

FIG. 11 is a diagram illustrating an example of a system configuration diagram of a bookbinding system 80 according to one embodiment of the present disclosure. As illustrated in FIG. 11, the bookbinding system 80 includes a sheet feeding apparatus 81, a first cutting apparatus 82, a second cutting apparatus 83, an accumulation apparatus 84, a bookbinding apparatus 85, and a three-side cutting apparatus 86, as the main configuration.

The sheet feeding apparatus 81 feeds the flat paper S one by one. The first cutting apparatus 82 cuts the flat paper S in a direction perpendicular to the transport direction. As the first cutting apparatus 82, the cutting apparatus 1 according to the first or second embodiment described above can be applied. The second cutting apparatus 83 cuts sheets, which have been cut by the first cutting apparatus 82, in a direction along the transport direction. As the cutting unit of the second cutting apparatus 83, for example, a slitter (round cutter) as disclosed in Japanese Patent Application Laid-Open No. 2014-201439 can be used.

The sheets cut by the second cutting apparatus 83 are accumulated on the accumulation apparatus 84. In the accumulation apparatus 84, the cut sheets corresponding to a single book are stacked, and thereby a sheet bundle (book block) is formed. Subsequently, the bookbinding apparatus 85 encloses the sheet bundle with a cover to bind a book. The three-side cutting apparatus 86 trims three sides of top edge/tail edge/fore edge. Accordingly, a book that is a final product is produced.

Note that the bookbinding system 80 described above is one applicable example of the cutting apparatus 1 and the control method of the rotary cutter 10 according to the present disclosure, and the applicable example is not limited thereto. That is, the cutting apparatus 1 and the control method of the rotary cutter 10 according to the present disclosure can be widely applied to a sheet processing system having a step of cutting flat sheets (sheets cut into a predetermined size) instead of roll paper in a direction intersecting the transport direction.

Although the present disclosure has been described above with reference to the embodiments, the technical scope of the present disclosure is not limited to the scope described in such embodiments. Various modifications or improvements can be made to the above embodiments within the scope not departing from the spirit of the disclosure, and forms with such modifications or improvements being added are also included in the technical scope of the present disclosure. Further, the above embodiments may be combined with each other as appropriate.

Further, the processing procedure described in the above embodiments is also an example, an unnecessary step may be deleted, a new step may be added, or processing order may be exchanged within the scope not departing from the spirit of the present disclosure.

### LIST OF REFERENCE NUMERALS

1 cutting apparatus
10 rotary cutter
11 base
12 cutting blade
13 fixed blade
15 cutter drive unit
20 sheet detection sensor (sheet detection device)
30 cutter controller (controller)
31 CPU
32 primary storage device
33 secondary storage device
34 communication interface
35 external interface
36 input device
37 display
60 transport unit (transport device)
61 belt conveyer
62 transport roller pair
62a upper roller
62b lower roller
63 transport drive unit
64 transport drive unit
65 transport controller
80 bookbinding system
81 sheet feeding apparatus
82 first cutting apparatus
83 second cutting apparatus
84 accumulation apparatus
85 bookbinding apparatus
86 three-side cutting apparatus
A transport direction
C circumferential length
C1 first threshold
C2 second threshold
Cs stop threshold
LN1 cutting line
LN2 cutting line
P0 reference position
Pc cut position
S flat paper

What is claimed is:

1. A cutting apparatus configured to cut a flat sheet transported by a transport device, the cutting apparatus comprising:
a rotary cutter configured to cut the flat sheet in a direction intersecting a transport direction;
a sheet detection device arranged upstream of the rotary cutter on a transport path of the flat sheet and configured to detect a sheet end of the flat sheet; and
a controller configured to control the rotary cutter,
wherein, after detection of the sheet end of the flat sheet by the sheet detection device, the controller controls a speed of the rotary cutter based on a transport speed of the transport device, a position of a cutting blade provided to the rotary cutter, and a cutting position on the flat sheet.

2. The cutting apparatus according to claim 1, wherein the controller performs a synchronization process to match a rotational speed of the rotary cutter with the transport speed of the flat sheet in response to detection of the sheet end of the flat sheet by the sheet detection device, and
performs a blade tip position adjustment process to increase or reduce the rotational speed of the rotary cutter so that the position of the cutting blade is aligned with the cutting position on the flat sheet in response to completion of the synchronization process.

3. The cutting apparatus according to claim 2, wherein after cutting the flat sheet and when the cutting is not final cutting the flat sheet or when a next flat sheet is detected by the sheet detection device, the controller performs a continuous cutting process to perform speed control of the rotary cutter based on a distance to a next cutting position.

4. The cutting apparatus according to claim 3, wherein in the continuous cutting process, when the distance to the next cutting position is less than or equal to a predetermined first threshold set to a value less than a circumferential length of the rotary cutter, the controller synchronizes the rotational speed of the rotary cutter with the transport speed by reducing the rotational speed of the rotary cutter after rotating the rotary cutter at a rotational speed higher than the transport speed of the flat sheet.

5. The cutting apparatus according to claim 3, wherein when the distance to the next cutting position is greater than or equal to a predetermined second threshold set to a value greater than a circumferential length of the rotary cutter and is less than or equal to a stop threshold, the controller synchronizes the rotational speed of the rotary cutter with the transport speed by increasing the rotational speed of the rotary cutter after rotating the rotary cutter at a rotational speed lower than the transport speed of the flat sheet, and
wherein the stop threshold is set greater than the second threshold and less than or equal to a transport distance corresponding to a period required for rotating the rotary cutter for one turn at the lowest speed.

6. The cutting apparatus according to claim 3, wherein when the distance to the next cutting position is greater than a predetermined first threshold set to a value less than a circumferential length of the rotary cutter and is less than a predetermined second threshold set to a value greater than the circumferential length of the rotary cutter, the controller maintains synchronization control for synchronization with the transport speed.

7. The cutting apparatus according to claim 1, wherein after cutting the flat sheet and when the cutting is final cutting the flat sheet and a next flat sheet is not detected by the sheet detection device, the controller stops the rotary cutter at a predetermined rotary angle.

8. The cutting apparatus according to claim 1, wherein when a distance to a next cutting position is greater than a stop threshold after cutting of the flat sheet, the controller stops the rotary cutter at a predetermined rotary angle, and
wherein the stop threshold is set to a transport distance or a value smaller than the transport distance by a predetermined value, the transport distance corresponding to a period required for rotating the rotary cutter for one turn at the lowest speed.

9. The cutting apparatus according to claim 2, wherein in a period from a start of cutting to an end of the cutting the flat sheet, the controller rotates the rotary cutter at a synchronization speed applied before the cutting regardless of the transport speed of the flat sheet.

10. The cutting apparatus according to claim 1, wherein the controller has a pulse table in which a number of transport pulses in accordance with the transport speed of the flat sheet is associated with a timing to output an instruction pulse related to a rotational speed of the rotary cutter, and the controller performs speed control of the rotary cutter by using the pulse table and the number of transport pulses input from the transport device.

11. The cutting apparatus according to claim 10, wherein the pulse table is provided for each speed level of the rotary cutter, and
wherein the controller changes the speed of the rotary cutter by switching the pulse table to be used.

12. A flat sheet processing system comprising the cutting apparatus according to claim 1.

13. A control method of a rotary cutter configured to cut a flat sheet in a direction intersecting a transport direction, the flat sheet being transported by a transport device, the control method comprising:
after detecting the flat sheet passing through a reference position virtually set upstream of the rotary cutter on a transport path of the flat sheet, controlling a speed of the rotary cutter based on a transport speed of the transport device, a position of a cutting blade provided to the rotary cutter, and a cutting position on the flat sheet.

14. A non-transitory computer-readable medium storing instructions that, when executed by a computer, cause the computer to perform the control method of the rotary cutter according to claim 13.
